(19) United States
(12) Patent Application Publication
(10) Pub. No.: US 2005/0227546 A1
(43) Pub. Date: Oct. 13, 2005

(54) Spring connector

(75) Inventor: Toru Sekiguchi, Yamanashi-ken (JP)

Correspondence Address: DENNISON, SCHULTZ, DOUGHERTY & MACDONALD, 1727 KING STREET, SUITE 105, ALEXANDRIA, VA, 22314, US

(73) Assignee: Citizen Electronics Co., Ltd.

(21) Appl. No.: 11/092,724

(22) Filed: Mar. 30, 2005

(30) Foreign Application Priority Data
Apr. 8, 2004 (JP) 2004-114422

(51) Int. Cl. H01R 13/24

(52) U.S. Cl. 439/700

(57) ABSTRACT

A spring connector comprises a supporting member, a cylindrical plunger, and a coil spring provided in the cylindrical plunger. The supporting member has a base, a pillar extended from the base, and a shoulder and a head having a diameter larger than that of the pillar. The upper end of the head has an inclined surface. The plunger has a closed upper end, an opening formed in an annular bent portion of a lower end thereof. An annular edge of the opening is slidably engaged with the supporting member at the shoulder thereof. The coil spring is provided between the closed upper end and the inclined surface of the head so that a shoulder formed on the head at a lower annular periphery is pressed against the annular bent portion of the opening.

### BACKGROUND OF THE INVENTION

The present invention relates to a connector used for surface mounting on a circuit substrate in an electronic device, particularly relates to a connector having a plunger resiliently urged by a spring so that the upper end of the connector may press terminal electrodes of electric parts to be electrically connected to the circuit substrate in the electronic device.

In an electronic device such as a portable telephone, a portable computer, and a game console, there are provided spring connectors for connecting battery, acoustic parts, peripheral circuits and other electric parts to a circuit substrate of the electronic device. Japanese Patent Application Laid-Open 2002-25657 discloses on page 3 and in FIG. 2(D), one of these spring connectors. The spring connector has a plunger which is slidably mounted in a tube and outwardly urged by a spring. The spring connector is secured to a circuit substrate and the plunger is pressed against a terminal electrode of the electric part in assembling process of the part in the device, thereby electrically connecting the part to the circuit substrate.

FIGS. 2 and 3 show similar conventional spring connectors.

Referring to FIG. 2, the spring connector comprises a cylindrical tube 11 made of metal, and a metal plunger 13 slidably inserted in the tube 11 and outwardly urged by a coil spring 12. A shoulder 13c of a flange 13a of the plunger 13 is pressed against a bent edge 11a of the tube 11 by the coil spring 12 so as not to slide out of the tube 11. The outer surfaces of the tube 11 and the plunger 13 are covered by nickel and gold plating. Both the tube 11 and the plunger 13 are formed by cutting work.

FIG. 3 shows another conventional spring connector provided with a plunger 13A. The plunger 13A has the flange 13a, an underside 13d of which is inclined so that the peripheral wall of the flange is pressed against the inner surface of the tube 11 in an inclined condition. Thus the flange is strongly pressed against the inner surface, thereby ensuring the electrical conductivity between the tube and the plunger. In the present spring connector, the plunger 13A is formed using a header instead of by cutting so that the manufacturing cost is decreased. The header is a processing machine to press or squash a metal material to form into a predetermined shape.

In each of the above described spring connectors, there is a problem of dirt entering the tube. Accordingly, the contact resistance between the plunger and the spring is unstable. Particularly in the case of the spring connector of FIG. 2, since the underside of the plunger is not inclined, the contact resistance is even more unstable. Moreover, although the plunger is formed with header in the spring connector of FIG. 3, since the tube must be manufactured by cutting in both cases, the manufacturing cost cannot be sufficiently decreased.

### SUMMARY OF THE INVENTION

An object of the present invention is to provide a spring connector which is excellent in performance and may be manufactured at a low cost.

According to the present invention, there is provided a spring connector comprising a supporting member having a base, a pillar formed on the base, a head having a diameter larger than that of the pillar, an annular shoulder formed between the pillar and the head, and an upper end of the head having an inclined surface, a cylindrical plunger having a closed upper end, an inner space, an opening formed in an annular bent portion of a lower end thereof, an annular edge of the opening being slidably engaged with a peripheral wall of the pillar, a coil spring provided in the inner space of the cylindrical plunger between the closed upper end and the inclined surface of the head so that the shoulder of the head is pressed against the annular bent portion of the opening.

The supporting member is formed by using a header, that is a processing machine to press or squash a metal material to form into a predetermined shape, and the annular bent portion of the plunger is formed by squeezing. Namely, a squeeze machine, after the supporting member is inserted in the plunger, squeezes the end of the plunger. The squeezing is a processing method to press the annular opening end of the plunger to be bent inwardly.

The surfaces of the supporting member and plunger are coated with Au plating.

These and other objects and features of the present invention will become more apparent from the following detailed description with reference to the accompanying drawings.

### BRIEF DESCRIPTION OF DRAWINGS

FIG. 1 is a sectional view of a spring connector according to the present invention;

FIG. 2 is a sectional view of a conventional spring connector; and

FIG. 3 is a sectional view showing another conventional spring connector.

### DETAILED DESCRIPTION OF THE PREFERRED EMBODIMENT

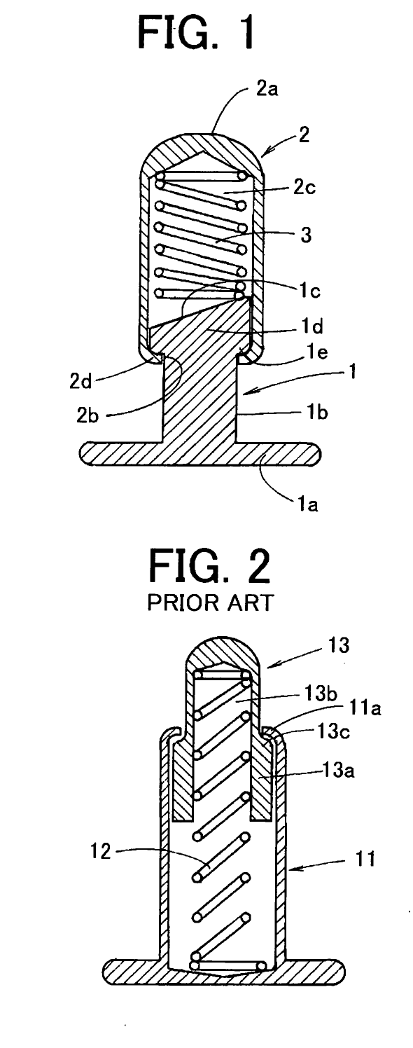

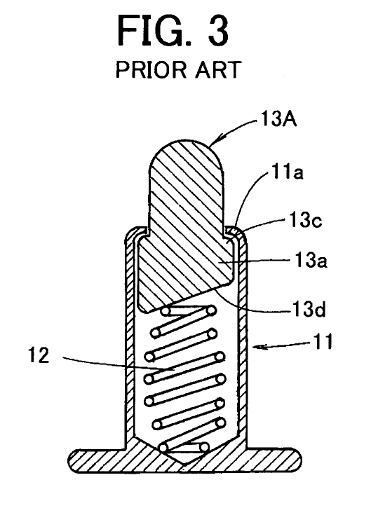

FIG. 1 is a sectional view of a spring connector according to the present invention.

Referring to FIG. 1, the spring connector comprises a cylindrical plunger 2 made of metal and a supporting member 1 made of metal and slidably inserted in the plunger 2. The supporting member 1 comprises a base 1a of a large diameter which is to be surface-mounted on a circuit substrate (not shown), a small diameter pillar 1b formed on the base 1a, and a head 1d having a diameter larger than that of the pillar 1b. The upper end of the head 1d is inclined with respect to the axis of the supporting member 1, thereby to form an inclined top surface 1c. An annular shoulder 1e is formed between the head 1d and the pillar 1b. Although the supporting member 1 may be machined, it is possible to manufacture the supporting member by press using a header comprising a die having a recess and a punch, in which case, the manufacturing cost can be reduced.

The cylindrical plunger 2 has a closed upper end 2a which is to be pressed against a terminal electrode of an electric part (not shown), and an annular bent portion 2d formed at a lower end thereof by squeezing action of a squeeze machine. An opening 2b is formed at a lower end of the cylindrical plunger 2 opposite the upper end 2a so as to be downwardly opened. A coil spring 3 is inserted in an inner space 2c inside the cylindrical plunger 2. An inner surface of the cylindrical plunger around the opening thereof is slidably pressed against the annular shoulder of the supporting member. The entire outer surfaces of both the cylindrical plunger 2 and the supporting member 1 are plated with gold.

In order to assemble the spring connector, the coil spring 3 is inserted in the cylindrical plunger 2 through the opening 2b. The head 1d of the supporting member 1 is then inserted in the cylindrical plunger 2 through the opening 2b. The periphery of the opening 2b is bent inward to form the annular bent portion 2d which covers the shoulder 1e of the supporting member 1. The bent portion 2d accordingly holds the supporting member 1 at the shoulder 1e so as to prevent the supporting member 1 from falling out of the plunger 2. The inner diameter of the inner space 2c of the cylindrical plunger 2 and the outer diameter of the head 1d of the supporting member 1 are set so that the plunger 2 is contacted with the head at a proper pressure so as to be smoothly slidable inside the plunger 2. The outer diameter of the pillar 1b and the inner diameter of the bent portion 2d are set so that the pillar 1b is smoothly slidable through the bent portion 2d. The cylindrical plunger 2 is formed by cutting and squeezing.

In operation, the base 1a of the supporting member 1 is mounted on a circuit substrate of an electronic device and the upper end 2a of the cylindrical plunger 2 is in contact with a terminal electrode of an electric part provided in the electronic device. When the cylindrical plunger 2 is pressed against the terminal electrode, the supporting member 1 is inserted deeper into the plunger 2 against the urging of the coil spring 3 so that the electrical connection between the terminal electrode and the circuit substrate is ensured. Since the pillar 1b of the supporting member 1 smoothly slides against the bent portion 2d of the plunger 2, and circumference surface of the head 1d is contacted with the inner surface of the plunger 2 at a proper pressure by the operation of the inclination of the inclined surface 1c, dirt is prevented from entering the cylindrical plunger through the opening 2b. Due to the inclination of the inclined surface 1c, the head 1d is pressed against the inner surface of the plunger 2. Thus the contact resistance is small and stable. Accordingly, the electrical conductivity between the cylindrical plunger 2 and the supporting member 1, and hence between the terminal electrode of the electric part and the circuit substrate is ensured.

Thus in accordance with the spring connector of the present invention, the head of the supporting member 1 is wrapped by the plunger and the opening of the plunger is downwardly opened so that dirt is not liable to enter the plunger, thereby rendering the contact resistance stable. Since the supporting member is provided with the inclined portion, the contact resistance is further maintained small and constant. The supporting member can be pressed using a header or cut and the plunger is formed by bending or by cutting so that the manufacturing cost of the spring connector is decreased. Thus inexpensive and reliable spring connector is provided.

While the invention has been described in conjunction with preferred specific embodiment thereof, it will be understood that this description is intended to illustrate and not limit the scope of the invention, which is defined by the following claims.

1. A spring connector comprising:
a supporting member having a base, a pillar formed on the base, a head having a diameter larger than that of the pillar, an annular shoulder formed between the pillar and the head, and an upper end of the head having an inclined surface;
a cylindrical plunger having a closed upper end, an inner space, an opening formed in an annular bent portion of a lower end thereof, an annular edge of the opening being slidably engaged with a peripheral wall of the pillar;
a coil spring provided in the inner space of the cylindrical plunger between the closed upper end and the inclined surface of the head so that the shoulder of the head is pressed against the annular bent portion of the opening.

2. The spring connector according to claim 1 wherein the supporting member is formed by using a header.

3. The spring connector according to claim 1 wherein the annular bent portion of the plunger is formed by a squeeze machine.

4. The spring connector according to claim 1 wherein surfaces of the supporting member and plunger are coated with Au plating.
